(19) United States
(12) Patent Application Publication
(10) Pub. No.: US 2008/0155699 A1
(43) Pub. Date: Jun. 26, 2008

(54) Output System, Output Data Management Apparatus, Network Device, Output Data Management Program, Output Program, and Output Method

(75) Inventor: Akihito Fukao, Nagano-ken (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/659,047

(22) PCT Filed: Jul. 28, 2005
(86) PCT No.: PCT/JP2005/014269

§ 371 Date: May 10, 2007

(30) Foreign Application Priority Data
Aug. 2, 2004 (JP) 2004-255163

(51) Int. Cl. G06F 21/24

(52) U.S. Cl. 726/26

(57) ABSTRACT

An output system is provided, which is capable of not only enhancing the security, but also performing outputs even when a number of output requests are issued simultaneously or almost simultaneous and suitable for relieving traffic concentration. A printer server 200 registers print data in a storage device 63 to have a correlation with user identification information in response to a print request from a host terminal 100. When an identification card is inserted into a card reader 86, a network printer 300 reads the user identification information from the identification card, and transmits the user identification information thus read to the printer server 200. Upon receipt of the user identification information, the printer server 200 retrieves print data corresponding to the user identification information identical with the received user identification information from the storage device 63, and transmits the retrieved print data to the network printer 300. Upon receipt of the print data, the network printer 300 executes printing on the basis of the received print data.

### TECHNICAL FIELD

The present invention relates to a system, an apparatus, a device, a program, and a method for performing an output, such as printing, on the basis of output data, and more particularly, to an output system, an output data management apparatus, a network device, an output data management program, an output program, and an output method capable of not only enhancing security, but also performing outputs even when a number of output requests are issued simultaneously or almost simultaneously and suitable for relieving traffic concentration.

### BACKGROUND ART

In a case where printing is executed on a network printer, when the user's host terminal is in a place remote from the network printer, after printed materials are outputted, they are left exposed until the user comes to the network printer, and there is a risk that a third party sees the contents of the printed materials. This raises a need to provide a security function to the network printer.

As a technique in the related art to enhance the security of the network printer, a printing system is disclosed, for example, in Patent Document 1 (JP-A-11-353137).

According to the invention disclosed in Patent Document 1, when a document from the host terminal is printed out, a print command (data written with an instruction instructing the printer to execute printing) appended with a code number is transmitted to the network printer. The network printer then generates print data on the frame memory according to the print command thus received, and accumulates compressed data. Print processing using the accumulated, compressed data is started when the user actually comes to where the network printer is installed and inputs the code number into the network printer. When a total volume of the compressed data exceeds the accumulation capacity of the network printer, the compressed data of jobs is deleted through the FIFO (First In First Out) method.

According to the invention disclosed in Patent Document 1, however, when a total volume of the compressed data exceeds the accumulation capacity, the compressed data of a job accumulated earlier is deleted first. Hence, when a number of print requests are issued simultaneously or almost simultaneously, compressed data of a job for which printing has not been completed may possibly be deleted, which raises a problem that printing cannot be executed in a reliable manner. Also, when a number of print requests are issued simultaneously or almost simultaneously, a huge volume of print data is transmitted to the network printer, which raises another problem that traffic is concentrated to the network printer. When the traffic is concentrated, two problems as follows are thought to occur. Firstly, when plural jobs each with a huge print data size are concentrated at a time, too much load is applied to the network processing portion at which the printer receives the data. This may possibly raise a problem that it is hard to access the printer. Secondly, when a huge volume of print data to be processed is received, it may take a longer time until it is printed out.

The invention was devised by focusing attention to the unsolved problems of the technique in the related art as discussed above, and therefore has an object to provide an output system, an output data management apparatus, a network device, an output data management program, an output program, and an output method capable of not only enhancing security, but also performing outputs even when a number of output requests are issued simultaneously or almost simultaneously and suitable for relieving traffic concentration.

### DISCLOSURE OF THE INVENTION

(Mode 1)

In order to achieve the above object, an output system in a mode 1 is an output system in which a network device that performs an output on the basis of output data and an output data management apparatus that manages the output data are connected to enable communications for allowing the network device to perform the output, characterized in that:

the output data management apparatus includes output data storage means for storing the output data and verified information to have a correlation with each other, verification information receiving means for receiving verification information that is checked against the verified information, output data retrieving means for retrieving the output data from the output data storage means according to the verification information received at the verification information receiving means, and output data transmitting means for transmitting the output data retrieved by the output data retrieving means; and

the network device includes verification information acquisition means for acquiring the verification information, verification information transmitting means for transmitting the verification information acquired by the verification information acquisition means to the output data management apparatus, output data receiving means for receiving the output data, and output means for performing the output on the basis of the output data received at the output data receiving means.

According to this configuration, in the network device, verification information is acquired by the verification information acquisition means, and the acquired verification information is transmitted to the output data management apparatus from the verification information transmitting means.

In the output data management apparatus, when the verification information is received at the verification information receiving means, output data is retrieved from the output data storage means according to the received verification information by the output data retrieving means, and the retrieved output data is transmitted from the output data transmitting means.

In the network device, when the output data is received at the output data receiving means, the output is performed by the output means on the basis of the received output data.

When configured in this manner, because the output is started when the user provides the verification information, a risk that a third party sees the output contents can be reduced, which provides an advantage that the security can be enhanced. In addition, because the output data correlated with the verified information is held in the output data management apparatus, there is no need for the network device to hold the output data correlated with the verified information. Hence, there is an advantage of making it possible to reduce a possibility that an output is not performed when a number of output requests are issued simultaneously or almost simultaneously in comparison with the related art. Further, even when a number of output requests are issued simultaneously or almost simultaneously, output data is transmitted to the network device only when the output is performed. Hence, there is an advantage that traffic concentration can be relieved in comparison with the related art. Furthermore, because it is configured in such a manner that the output data is acquired by transmitting the verification information from the network device, in a case where plural network devices are present, there is an advantage that an output can be performed using any network device.

The verification information acquisition means can be of any configuration as long as it can acquire the verification information. For example, the verification information may be inputted from an input device or the like, or the verification information may be obtained or received from an external terminal or the like. Alternatively, the verification information may be read out from a storage device, a storage medium, a living individual, a human body, etc. Acquisition, therefore, includes at least the input, obtainment, reception, and readout. The same can be said in a network device in a mode 12 below.

Also, the output means can be of any configuration as long as it can perform an output on the basis of the output data, and includes, for example, printing means for executing printing on the basis of print data, display means for performing a display on the basis of display data, or sound output means for outputting a sound on the basis of sound data. A network device having the display means includes, for example, a projector and an LCD (Liquid Crystal Display) device. The same can be said in the network device in the mode 12 below.

Also, the output data includes print data, display data, and sound data. A correspondence of these kinds of data to the network device is as follows: print data is used, for example, in a network printer, display data is used, for example, in a projector, and sound data is used, for example, in a stereo set. The same can be said in an output data management apparatus in a mode 7, the network device in the mode 12, an output data management program in a mode 15, an output control program in a mode 20, and an output method in a mode 23 below.

Also, the verification information means information used to retrieve the output data by being checked against the verified information. It may be information identical with the verified information, or information different from the verified information. For the retrieval of the output data, for example, whether the verification information and the verified information establish a specific relation is judged. When it is judged that a specific relation is established, the output data corresponding to the verified information in question is acquired from the output data storage means. To establish a specific relation means, for example, either the verification information and the verified information coincide with each other or have a discrepancy, either a computation result of the verification information in accordance with a predetermined arithmetic expression and the verified information coincide with each other or have a discrepancy, or either a computation result of the verification information in accordance with a predetermined arithmetic expression and a computation result of the verified information in accordance with a predetermined arithmetic information coincide with each other or have a discrepancy. In the case of a discrepancy, for example, a country code is included in the verification information, and when Japan is specified in the country code, the output system is configured in such a manner that an output can be performed in a country other than Japan. Also, a public key encryption system or a hash function can be used as the predetermined arithmetic expression. The same can be said in the output data management apparatus in the mode 7, the network device in the mode 12, the output data management program in the mode 15, the output control program in the mode 20, and the output method in the mode 23 below.

Also, the verified information means information checked against the verification information and used to confirm whether it establishes a specific relation with the verification information, and it is paired with the verification information. The same can be said in the output data management apparatus in the mode 7, the network device in the mode 12, the output data management program in the mode 15, the output control program in the mode 20, the output method in the mode 23 below.

The output data storage means stores output data using arbitrary means at arbitrary timing, or it may have stored the output data previously. Alternatively, it may store output data through inputs from the outside when the system is activated without having to pre-store the output data. The same can be said in the output data management apparatus in the mode 7 below.

Also, the output data management apparatus may be configured as a device using apparatus that uses the network device, a server, or another terminal. Hence, output data storage means with a relatively large storage capacity can be used; moreover, a storage capacity of the output data storage means can be readily increased. Hence, when a number of output requests are issued simultaneously or almost simultaneously, it is possible to reduce a risk that non-processed output data is deleted, which can in turn bring an advantage of making it possible to reduce a possibility that an output is not performed. The same can be said in the output data management apparatus in the mode 7, the output management program in the mode 15, and the output method in the mode 23 below.

Also, to perform an output on the basis of the output data means, for example, when the output data is sound data, it means an output of sounds, when the output data is video data, it means playing back of videos, and when the output data is print data, it means to execute printing. Print data includes, for example, intermediate data, such as a PDL, and image data, such as a bit map. Hence, when the print data is the intermediate data, the print data is converted to a format that the printer can understand, and when the print data is the image data, the print data is outputted intact. The same can be said in the network device in the mode 12, the output control program in the mode 20, and the output method in the mode 23 below.

Also, the management of the output data includes storage, retrieval, and transmission of the output data. The same an be said in the output data management apparatus in the mode 7, the output data management program in the mode 15, and the output method in the mode 23.

Also, the output data transmitting means can be of any configuration as long as it can transmit the output data. For example, it may transmit the output data directly to the network device, or it may transmit the output data indirectly to the network device. A case where the output data is transmitted indirectly includes, for example, an instance that the output data management apparatus and an external terminal are connected to enable communications, so that the output data is transmitted to the network device by way of the external terminal. In other words, transmission of the output data can be performed through a cooperation of the output data management apparatus and one or more than one external terminal. Hereinafter, the same can be said in a case where information is transmitted to a subject.

(Mode 2)

Further, as output system in a mode 2 is the output system according to the mode 1, further including:

a device using apparatus that uses the network device and is connected to the system to enable communications,

wherein the device using apparatus includes output data generating means for generating the output data, and second output data transmitting means for transmitting the output data generated in the output data generating means and the verified information to the output data management apparatus; and

the output data management apparatus further includes second output data receiving means for receiving the output data and the verified information, and output data registration means for registering the output data and the verified information received at the second output data receiving means in the output data storage means to have a correlation with each other.

When configured in this manner, in the device using apparatus, the output data is generated in the output data generating means, and the generated output data and the verified information are transmitted to the output data management apparatus from the second output data transmitting means.

In the output data management apparatus, when the output data and the verified information are received at the second output data receiving means, the output data and the verified information thus received are registered in the output data storage means by the output data registration means to have a correlation with each other.

Hence, because the output data is generated in the device using apparatus, there is an advantage that a degree of freedom is large in generation of output data.

(Mode 3)

Further, an output system in a mode 3 is the output system according to the mode 1, wherein:

the output data management apparatus further includes output data generating means for generating the output data, and output data registration means for registering the output data generated in the output data generating means and the verified information in the output data storage means.

When configured in this manner, in the output data management apparatus, the output data is generated in the output data generating means, and the generated output data and the verified information are registered in the output data storage means by the output data registration means to have a correlation with each other.

Hence, when the output system is configured in such a manner that the user's own PC is used as the output data management apparatus, because the output data is generated in the output data management apparatus, there is an advantage that the need to newly provide a server can be eliminated. Also, because the output data is held in the user's own PC, there is an advantage that the security is high.

(Mode 4)

Further, an output system in a mode 4 is the output system according any of the modes 1 through 3, wherein:

the network device further includes reply request transmitting means for transmitting a reply request through a simultaneous transmission system, and position information receiving means for receiving position information of the output data management apparatus;

the verification information transmitting means transmits the verification information acquired by the verification information acquisition means to the output data management apparatus according to the position information received at the position information receiving means; and

the output data management apparatus further includes reply request receiving means for receiving the reply request, and position information transmitting means for transmitting the position information to the network device as a request sender in response to the reply request received at the reply request receiving means.

When configured in this manner, in the network device, a reply request is transmitted from the reply request transmitting means through a simultaneous transmission system.

In the output data management apparatus, when the reply request is received at the reply request receiving means, the position information of the output data management apparatus is transmitted to the request-sender network device from the position information transmitting means in response to the received reply request.

In the network device, when the position information is received at the position information receiving means, the acquired verification information is transmitted to the output data management apparatus from the verification information transmitting means according to the received position information.

Hence, because the need to set the position information of the output data management apparatus in the network device can be eliminated, there is an advantage that the network device can be set with ease. Further, because the need to set the position information of the output data management apparatus in the network device can be eliminated, there is an advantage that the settings in the network device need not be corrected when the position information of the output data management apparatus is changed.

The reply request referred to herein means a request requesting the output data management apparatus to transmit the position information, so that the network device obtains the position information of the output data management apparatus. The same can be said in an output data management apparatus in a mode 10, a network device in a mode 13, an output data management program in a mode 18, an output control program in a mode 21, and an output method in a mode 26 below.

Also, the simultaneous transmission system means a communication method for transmitting data to plural terminals at a time, such as broadcast communication and multicasting communication. The same can be said in the network device in the mode 13, the output control program in the mode 21, and the output method in the mode 26 below.

Also, the position information includes, for example, an IP address, a port number, and a URL (Uniform Resource Locator). The same can be said in an output system in a mode 6, the output data management apparatus in the mode 10, network devices in modes 13 and 14, the output data management program in the mode 18, output control programs in modes 21 and 22, and output methods in mode 26 and 28.

(Mode 5)

Further, an output system in a mode 5 is the output system according to the mode 4, wherein:

the output data storage means stores the output data to have a correlation with driver identification information about a device driver of the network device and the verified information; and

the position information transmitting means does not transmit the position information to the network device as the request sender when judging that the driver identification information corresponding to the network device as the request sender is absent in the output data storage means.

When configured in this manner, in the output data management apparatus, when it is judged that the driver identification information corresponding to the request-sender network device is absent in the output data storage means, the position information is not transmitted to the request-sender network device from the position information transmitting means.

Hence, because the position information of the output data management apparatus that is incompatible with the network device is not transmitted, there is an advantage that an increase of a traffic volume and processing load can be suppressed. In addition, because unnecessary address information is not transmitted or received over the network, there is an advantage that a risk of leakage of address information can be reduced.

Not to transmit the position information means to take no action, not to respond to a request from the network device, and to ignore a request from the network device. The same can be said in an output data management apparatus in a mode 11, an output data management program in a mode 19, and an output method in a mode 27.

Also, the request-sender network device means a network device that issued a reply-request. The same can be said in the output data management apparatus in the mode 11, the output data management program in the mode 19, and the output method in the mode 27.

(Mode 6)

Further, an output system in a mode 6 is the output system according to any of the modes 1 through 3, wherein:

the network device further includes position information setting means for setting position information of the output data management apparatus; and

the verification information transmitting means transmits the verification information acquired by the verification information acquisition means to the output data management apparatus according to the position information set by the position information setting means.

When configured in this manner, in the network device, when the position information is set by the position information setting means, the acquired verification information is transmitted to the output data management apparatus from the verification information transmitting means according to the position information thus set.

Hence, because the network device communicates the designated output data management apparatus alone, there is an advantage that stealing or falsification of output data through impersonation can be prevented.

(Mode 7)

Meanwhile, in order to achieve the above object, an output data management apparatus in a mode 7 is an output data management apparatus that manages output data, characterized by including

output data storage means for storing the output data and verified information to have a correlation with each other, verification information receiving means for receiving verification information that is checked against the verified information, output data retrieving means for retrieving the output data from the output data storage means according to the verification information received at the verification information receiving means, and output data transmitting means for transmitting the output data retrieved by the output data retrieving means.

When configured in this manner, functions equivalent to those of the output data management apparatus in the output system in the mode 1 can be achieved. Hence, advantages equivalent to those of the output system in the mode 1 can be obtained.

(Mode 8)

Further, an output data management apparatus in a mode 8 is the output data management apparatus according to the mode 7, further including:

second output data receiving means for receiving the output data and the verified information, and output data registration means for registering the output data and the verified information received at the second output data receiving means in the output data storage means to have a correlation with each other.

When configured in this manner, functions equivalent to those of the output data management apparatus in the output system in the mode 2 can be achieved. Hence, advantages equivalent to those of the output system in the mode 2 can be obtained.

(Mode 9)

Further, an output data management apparatus in a mode 9 is the output data management apparatus according to the mode 7, further including:

output data generating means for generating the output data, and output data registration means for registering the output data generated in the output data generating means and the verified information in the output data storage means.

When configured in this manner, functions equivalent to those of the output data management apparatus in the output system in the mode 3 can be achieved. Hence, advantages equivalent to those of the output system in the mode 3 can be obtained.

(Mode 10)

Further, an output data management apparatus in a mode 10 is the output data management apparatus according to any of the modes 7 through 9, further including:

reply request receiving means for receiving a reply request, and position information transmitting means for transmitting position information of the output data management apparatus to the network device as a request sender in response to the reply request received at the reply request receiving means.

When configured in this manner, functions equivalent to those of the output data management apparatus in the output system in the mode 4 can be achieved. Hence, advantages equivalent to those of the output system in the mode 4 can be obtained.

(Mode 11)

Further, an output data management apparatus in a Mode 11 is the output data management apparatus according to the mode 10, wherein:

the output data storage means stores the output data to have a correlation with driver identification information about a device driver of the network device and the verified information; and

the position information transmitting means does not transmit the position information to the network device as the request sender when judging that the driver identification information corresponding to the network device as the request sender is absent in the output data storage means.

When configured in this manner, functions equivalent to those of the output data management apparatus in the output system in the mode 5 can be achieved. Hence, advantages equivalent to those of the output system in the mode 5 can be obtained.

(Mode 12)

Meanwhile, in order to achieve the above object, a network device in a mode 12 is a network device that performs an output on the basis of output data, characterized by including:

verification information acquisition means for acquiring verification information, verification information transmitting means for transmitting the verification information acquired by the verification information acquisition means to an output data management apparatus, output data receiving means for receiving the output data, and output means for performing the output on the basis of the output data received at the output data receiving means.

When configured in this manner, functions equivalent to those of the network device in the output system in the mode 1 can be achieved. Hence, advantages equivalent to those of the output system in the mode 1 can be obtained.

(Mode 13)

Further, a network device in a mode 13 is the network device according to the mode 12, further including:

reply request transmitting means for transmitting a reply request through a simultaneous transmission system, and position information receiving means for receiving position information of the output data management apparatus,

wherein the verification information transmitting means transmits the verification information acquired by the verification information acquisition means to the output data management apparatus according to the position information received at the position information receiving means.

When configured in this manner, functions equivalent to those of the network device in the output system in the mode 4 can be achieved. Hence, advantages equivalent to those of the output system in the mode 4 can be obtained.

(Mode 14)

Further, a network device in a mode 14 is the network device according to the mode 12, further including:

position information setting means for setting position information of the output data management apparatus,

wherein the verification information transmitting means transmits the verification information acquired by the verification information acquisition means to the output data management apparatus according to the position information set by the position information setting means.

When configured in this manner, functions equivalent to those of the network device in the output system in the mode 6 can be achieved. Hence, advantages equivalent to those of the output system in the mode 6 can be obtained.

(Mode 15)

Meanwhile, in order to achieve the above object, an output data management program in a mode 15 is an output data management program that manages output data, characterized by including a program causing a computer to perform processing including:

a verification information receiving step of receiving verification information that is checked against verified information, an output data retrieving step of retrieving the output data from output data storage means having stored the output data and the verified information to have a correlation with each other according to the verification information received in the verification information receiving step, and an output data transmitting step of transmitting the output data retrieved in the output data retrieving step.

When configured in this manner, the computer reads the program, and as the computer performs processing according to the program thus read, functions and advantages equivalent to those of the output data management apparatus in the mode 7 can be obtained.

(Mode 16)

Further, an output data management program in a Mode 16 is the output data management program according to the mode 15, wherein the program includes a program causing the computer to perform the processing further including:

a second output data receiving step of receiving the output data and the verified information, and an output data registering step of registering the output data and the verified information received in the second output data receiving step in the output data storage means to have a correlation with each other.

When configured in this manner, the computer reads the program, and as the computer performs processing according to the program thus read, functions and advantages equivalent to those of the output data management apparatus in the mode 8 can be obtained.

(Mode 17)

Further, an output data management program in a mode 17 is the output data management program according to the mode 15, wherein the program includes a program causing the computer to perform the processing further including:

an output data generating step of generating the output data, and an output data registering step of registering the output data generated in the output data generating step and the verified information in the output data storage means.

When configured in this manner, the computer reads the program, and as the computer performs processing according to the program thus read, functions and advantages equivalent to those of the output data management apparatus in the mode 9 can be obtained.

(Mode 18)

Further, an output data management program in a mode 18 is the output data management program according to any of the modes 15 through 17, wherein the program includes a program causing the computer to perform the processing further including:

a reply request receiving step of receiving a reply request, and a position information transmitting step of transmitting position information of the output data management apparatus to the network device as a request sender in response to the reply request received in the reply request receiving step.

When configured in this manner, the computer reads the program, and as the computer performs processing according to the program thus read, functions and advantages equivalent to those of the output data management apparatus in the mode 10 can be obtained.

(Mode 19)

Further, an output data management program in a mode 19 is the output data management program according to the mode 18, wherein:

the output data storage means stores the output data to have a correlation with driver identification information about a device driver of the network device and the verified information; and

in the position information transmitting step, the position information is not transmitted to the network device as the request sender when it is judged that the driver identification information corresponding to the network device as the request sender is absent in the output data storage means.

When configured in this manner, the computer reads the program, and as the computer performs processing according to the program thus read, functions and advantages equivalent to those of the output data management apparatus in the mode 11 can be obtained.

(Mode 20)

Meanwhile, in order to achieve the above object, an output control program in a mode 20 is an output control program that performs an output on the basis of output data, characterized by including a program causing a computer to perform processing including:

a verification information acquiring step of acquiring verification information, a verification information transmitting step of transmitting the verification information acquired in the verification information acquiring step to an output data management apparatus, an output data receiving step of receiving the output data, and an output step of performing the output on the basis of the output data received in the output data receiving step.

When configured in this manner, the computer reads the program, and as the computer performs processing according to the program thus read, functions and advantages equivalent to those of the network device in the mode 12 can be obtained.

The verification information acquiring step can be of any configuration as long as the verification information can be acquired. For example, the verification information may be inputted from an input device or the like, or the verification information may be obtained or received from an external terminal or the like. Alternatively, the verification information may be read out from a storage device, a storage medium, a living individual, a human body, etc. Acquisition, therefore, includes at least the input, obtainment, reception, and readout. The same can be said in the output method in the mode 23 below.

Also, the output step can be of any configuration as long as an output can be performed on the basis of the output data, and includes, for example, a print step of executing printing on the basis of print data, a display step of performing a display on the basis of display data, or a sound output step of outputting a sound on the basis of sound data. The display step includes, for example, performing a display using a projector or an LCD device. The same can be said in the output method in the mode 23 below.

(Mode 21)

Further, an output control program in a mode 21 is the output control program according to the mode 20, wherein the program includes a program causing the computer to perform the processing further including:

a reply request transmitting step of transmitting a reply request through a simultaneous transmission system, and a position information receiving step of receiving position information of the output data management apparatus,

wherein, in the verification information transmitting step, the verification information acquired in the verification information acquiring step is transmitted to the output data management apparatus according to the position information received in the position information receiving step.

When configured in this manner, the computer reads the program, and as the computer performs processing according to the program thus read, functions and advantages equivalent to those of the network device in the mode 13 can be obtained.

(Mode 22)

Further, an output control program in a mode 22 is the output control program according to the mode 20, wherein the program includes a program causing the computer to perform the processing further including:

a position information setting step of setting position information of the output data management apparatus,

wherein, in the verification information transmitting step, the verification information acquired in the verification information acquiring step is transmitted to the output data management apparatus according to the position information set in the position information setting step.

When configured in this manner, the computer reads the program, and as the computer performs processing according to the program this read, functions and advantages equivalent to those of the network device in the mode 14 can be obtained.

(Mode 23)

Meanwhile, in order to achieve the above object, an output method in a mode 23 is an output method for performing an output by means of a network device by connecting the network device that performs an output on the basis of output data and an output data management apparatus that manages the output data to enable communications, characterized by including:

for the network device, a verification information acquiring step of acquiring verification information that is checked against verified information, and a verification information transmitting step of transmitting the verification information acquired in the verification information acquiring step to the output data management apparatus;

for the output data management apparatus, a verification information receiving step of receiving the verification information, an output data retrieving step of retrieving the output data from output data storage means having stored the output data and the verified information to have a correlation with each other according to the verification information received in the verification information receiving step, and an output data transmitting step of transmitting the output data retrieved in the output data retrieving step; and

further, for the network device, an output data receiving step of receiving the output data, and an output step of performing the output on the basis of the output data received in the output data receiving step.

Advantages equivalent to those of the output system in the mode 1 can be thus obtained.

(Mode 24)

Further, an output method in a mode 24 is the output method according to the mode 23, wherein:

a device using apparatus that uses the network device is further connected to the system to enable communications;

for the device using apparatus, the method further includes an output data generating step of generating the output data, and a second output data transmitting step of transmitting the output data generated in the output data generating step and the verified information to the output data management apparatus; and

for the output data management apparatus, the method further includes a second output data receiving step of receiving the output data and the verified information, and an output data registering step of registering the output data and the verified information received in the second output data receiving step in the output data storage means to have a correlation with each other.

Advantages equivalent to those of the output system in the mode 2 can be thus obtained.

(Mode 25)

Further, an output method in a mode 25 is the output method according to the mode 23, wherein:

for the output data management apparatus, the method further includes an output data generating step of generating the output data, and an output data registering step of registering the output data generated in the output data generating step and the verified information in the output data storage means.

Advantages equivalent to those of the output system in the mode 3 can be thus obtained.

(Mode 26)

Further, an output method in a mode 26 is the output method according to any of the modes 23 through 25, wherein:

for the network device, the method further includes a reply request transmitting step of transmitting a reply request through a simultaneous transmission system;

for the output data management apparatus, the method further includes a reply request receiving step of receiving the reply request, and a position information transmitting step of transmitting position information of the output data management apparatus to the network device as a request sender in response to the reply request received in the reply request receiving step;

for the network device, the method further includes a position information receiving step of receiving the position information; and

in the verification information transmitting step, the verification information acquired in the verification information acquiring step is transmitted to the output data management apparatus according to the position information received in the position information receiving step.

Advantages equivalent to those of the output system in the mode 4 can be thus obtained.

(Mode 27)

Further, an output method in a mode 27 is the output method according to the mode 26, wherein:

the output data storage means stores the output data to have a correlation with driver identification information about a device driver of the network device and the verified information; and

in the position information transmitting step, the position information is not transmitted to the network device as the request sender when it is judged that the driver identification information corresponding to the network device as the request sender is absent in the output data storage means.

Advantages equivalent to those of the output system in the mode 5 can be thus obtained.

(Mode 28)

Further, an output method in a mode 28 is the output method according to any of the modes 23 through 25, wherein:

for the network device, the method further includes a position information setting step of setting position information of the output data management apparatus; and

in the verification information transmitting step, the verification information acquired in the verification information acquiring step is transmitted to the output data management apparatus according to the position information set in the position information setting step.

Advantages equivalent to those of the output system in the mode 6 can be thus obtained.

### BRIEF DESCRIPTION OF THE DRAWINGS

FIG. 1 is a functional block diagram schematically showing a function of a network system;

FIG. 2 is a block diagram showing the hardware configuration of a host terminal 100;

FIG. 3 shows a flowchart detailing print request processing;

FIG. 4 shows a flowchart detailing identification information providing processing;

FIG. 5 is a block diagram showing the hardware configuration of a printer server 200;

FIG. 6 is a view showing the data structure of a print data management table 400;

FIG. 7 shows a flowchart detailing print request acceptance processing;

FIG. 8 shows a flowchart detailing address information providing processing;

FIG. 9 shows a flowchart detailing print data retrieval processing;

FIG. 10 is a block diagram showing the hardware configuration of a network printer 300;

FIG. 11 shows a flowchart detailing identification card read processing;

FIG. 12 shows a flowchart detailing print control processing; and

FIG. 13 is a functional block diagram schematically showing a function of a network system.

### BEST MODE FOR CARRYING OUT THE INVENTION

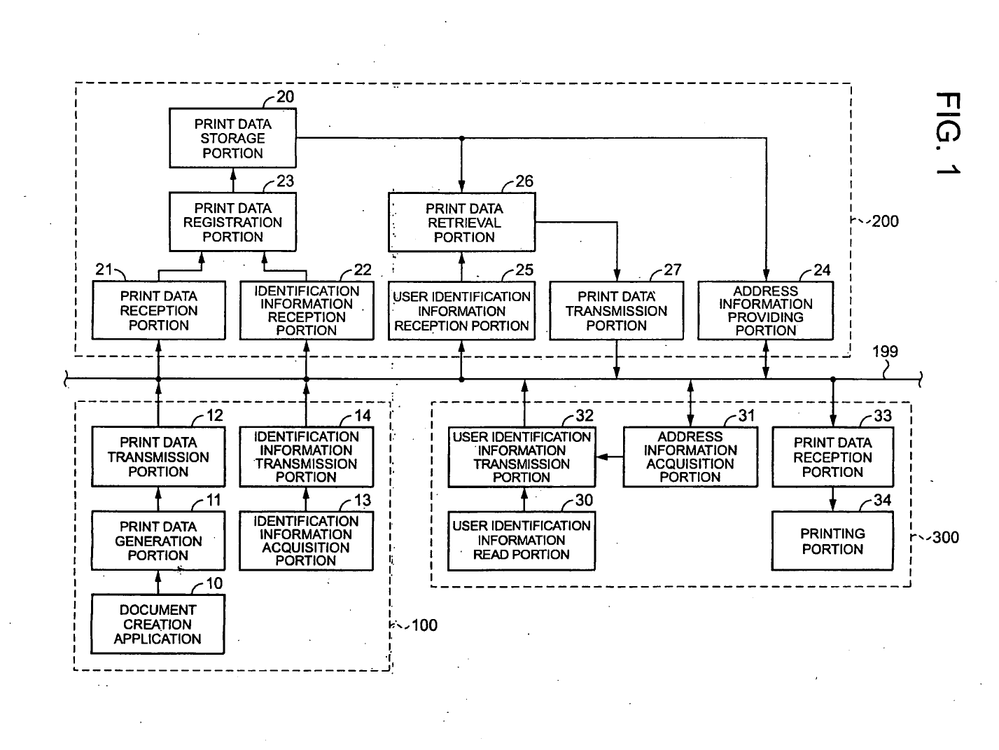

Hereinafter, an embodiment of the invention will be described with reference to the drawings. FIG. 1 through FIG. 12 are views showing an embodiment of an output system, an output data management apparatus a network device, an output data management program, an output program, and an output method of the invention.

As is shown in FIG. 1, in this embodiment, the output system, the output data management apparatus, the network device, the output data management program, the output program, and the output method of the invention are applied to a case where printing is executed on a network printer 300 using an identification card.

Firstly, a function of the network system adopting the invention will be described schematically with reference to FIG. 1.

FIG. 1 is a functional block diagram schematically showing a function of the network system.

As is shown in FIG. 1, plural host terminals 100, plural printer servers 200, and a network printer 300 are connected to a network 199.

Each host terminal 100 includes a document creation application 10 that enables the user to edit document data, a print data generation portion 11 that generates print data on the basis of document data edited with the use of the document creation application 10, and a print data transmission portion 12 that transmits print data generated in the print data generation portion 11 to the printer server 200.

The host terminal 100 further includes an identification information acquisition portion 13 that acquires user identification information of the user currently using the host terminal 100 and driver identification information about the printer driver of the network printer 300 that the host terminal 100 uses, and an identification information transmission portion 14 that transmits the user identification information and the driver identification information acquired by the identification information acquisition portion 13 to the printer server 200.

Each printer server 200 includes a print data storage portion 20, a print data reception portion 21 that receives print data, an identification information reception portion 22 that receives the user identification information and the driver identification information, and a print data registration portion 23 that registers the print data received at the print data reception portion 21 in the print data storage portion 20 to have a correlation with the user identification information and the driver identification information received at the identification information reception portion 22.

The printer server 200 further includes an address information providing portion 24 that provides address information of the printer server 200 to the network printer 300 in response to a reply request from the network printer 300, a user identification information reception portion 25 that receives the user identification information, a print data retrieval portion 26 that retrieves print data from the print data storage portion 20 according to the user-identification information received at the user identification information reception portion 25, and a print data transmission portion 27 that transmits print data retrieved by the print data retrieval portion 26 to the network printer 300.

The network printer 300 includes a user identification information read portion 30 that reads the user identification information from an identification card comprising an IC card or the like, an address information acquisition portion 31 that acquires address information from the printer server 200 by transmitting a reply request through broadcast communication, and a user identification information transmission portion 32 that transmits the user identification information read in the user identification information read portion 30 to the printer server 200 according to the address information acquired by the address information acquisition portion 31.

The network printer 300 further includes a print data reception portion 33 that receives print data, and a printing portion 34 that executes printing on the basis of print data received at the print data reception portion 33.

The configuration of the host terminal 100 will now be described.

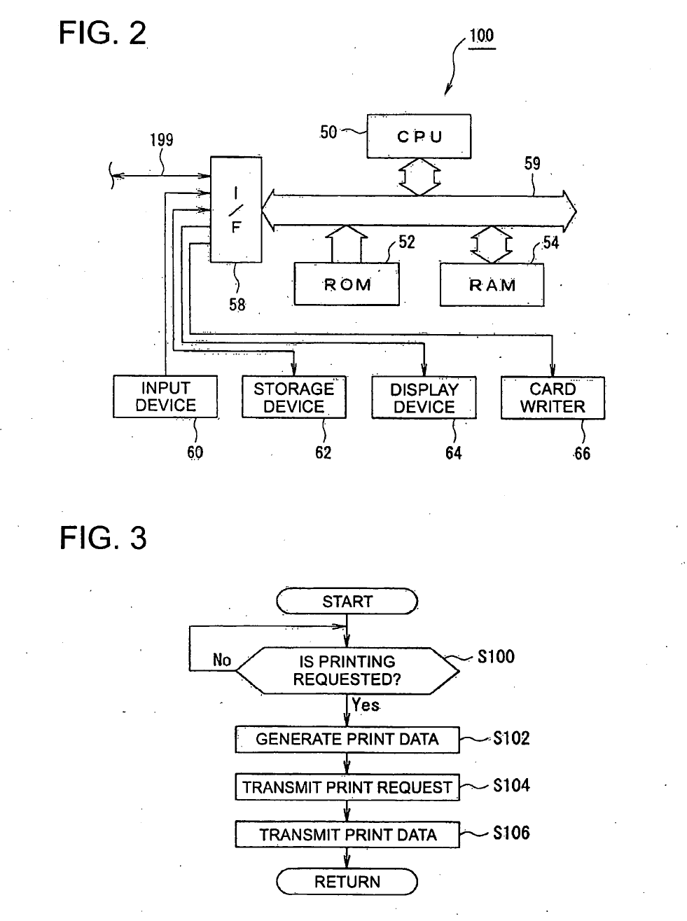

FIG. 2 is a block diagram showing the hardware configuration of the host terminal 100.

As is shown in FIG. 2, the host terminal 100 comprises a CPU 50 that performs a computation and controls the overall system according to a control program, a ROM 52 that pre-stores the control program of the CPU 50 or the like in a specific region, a RAM 54 that stores data read out from the ROM 52 or the like and a computation result needed for a computation process in the CPU 50, and an I/F 58 that transmits incoming/outgoing data from/to an external device. These components are interconnected via a bus 59 serving as a signal line for transferring data to enable mutual data transmission and reception.

External devices are connected to the I/F 58, such as an input device 60 comprising a keyboard or a mouse serving as a human interface to enable data inputs, a storage device 62 that stores data or a table in the form of files, a display device 64 that displays a screen according to an image signal, a card writer 66 that writes user identification information into an inserted identification card, and a signal line for establishing a connection with the network 199.

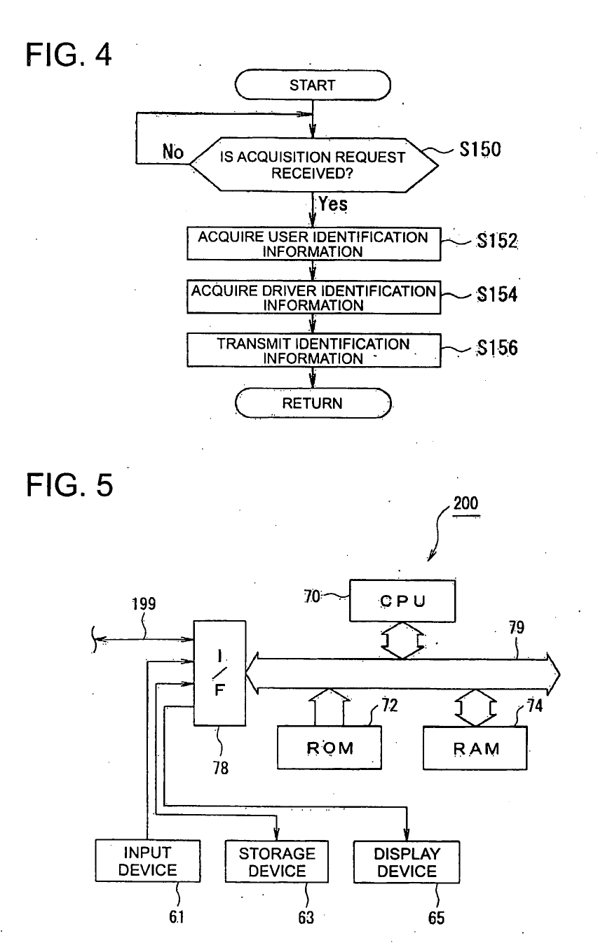

The CPU 50 comprises a micro processing unit or the like, and runs a certain program stored in a specific region of the ROM 52, thereby performing print request processing and identification information providing processing detailed, respectively, in the flowcharts of FIG. 3 and FIG. 4, in a time-divisional manner according to the program.

Initially, the print request processing will be described in detail with reference to FIG. 3.

FIG. 3 is a flowchart detailing the print request processing.

The print request processing is processing to request the printer server 200 to execute printing, and when performed in the CPU 50, as is shown in FIG. 3, it first proceeds to Step S100.

In Step S100, whether printing is requested from the document creation application 10 is judged. When it is judged that the printing is requested (Yes), the flow proceeds to Step S102, and when it is judged otherwise (No), the flow is suspended in Step S100 until the printing is requested.

In Step S102 print data is generated by means of the printer driver on the basis of the document data edited with the use of the document creation application 10. The flow then proceeds to Step S104 in which a print request is transmitted to the printer server 200. The flow then proceeds to Step S106 in which the generated print data is transmitted to the printer server 200, at which point a sequence of the processing is terminated and the original processing is resumed.

The identification information providing processing will now be described in detail with reference to FIG. 4.

FIG. 4 is a flowchart detailing the identification information providing processing.

The identification information providing processing is processing to provide the printer server 200 with the user identification information and the driver identification information in response to a request from the printer server 200, and when performed in the CPU 50, as is shown in FIG. 4, it first proceeds to Step S150.

In Step S150, whether an acquisition request for the identification information is received is judged. When it is judged that the acquisition request for the identification information is received (Yes), the flow proceeds to Step S152, and when it is judged otherwise (No), the flow is suspended in Step S150 until the acquisition request for the identification information is received.

In Step S152, the user identification information of the user currently using the host terminal 100 is acquired. The flow then proceeds to Step S154 in which the driver identification information about the printer driver used in the processing in Step S102 is acquired. The flow then proceeds to Step S156 in which the user identification information and the driver identification information thus acquired are transmitted to the printer server 200, at which point a sequence of the processing is terminated and the original processing is resumed.

The configuration of the printer server 200 will now be described.

FIG. 5 is a block diagram showing the hardware configuration of the printer server 200.

As is shown in FIG. 5, the printer server 200 comprises a CPU 70 that performs a computation and controls the overall system according to a control program, a ROM 72 that pre-stores the control program of the CPU 70 or the like in a specific region, a RAM 74 that stores data read out from the ROM 72 or the like and a computation result needed for a computation process in the CPU 70, and an I/F 78 that transmits incoming/outgoing data from/to an external device. These components are interconnected via a bus 79 serving as a signal line for transferring data to enable mutual data reception and transmission.

External devices are connected to the I/F 78, such as an input device 61 comprising a keyboard or a mouse serving as a human interface to enable data inputs, a storage device 63 that stores data or a table in the form of files, a display device 65 that displays a screen according to an image signal, and a signal line for establishing a connection with the network 199.

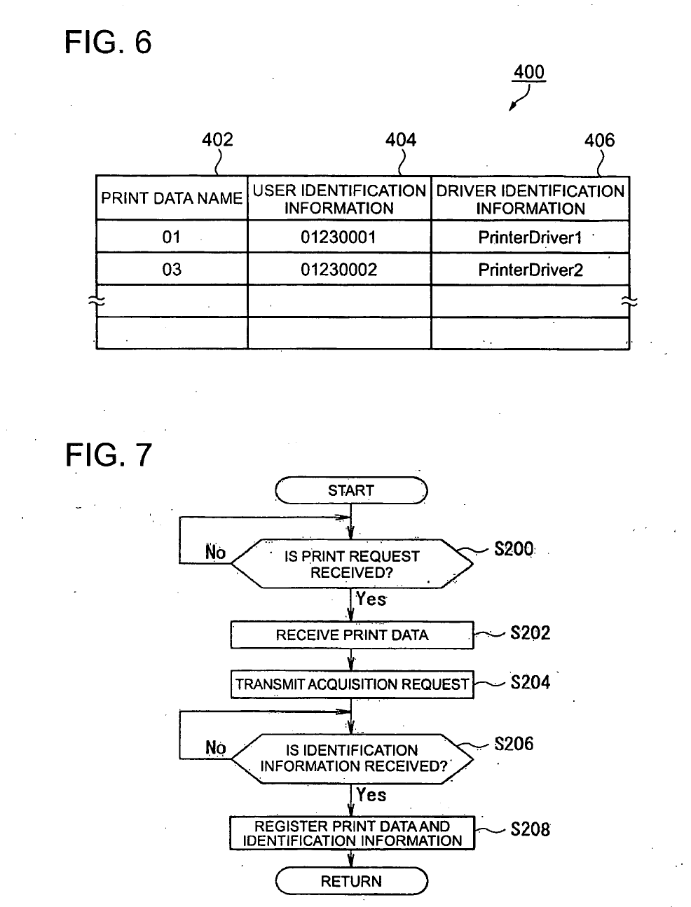

FIG. 6 is a view showing the data structure of a print data management table 400.

The storage device 63 registers print data, and it also stores the print data management table 400 that manages print data as is shown FIG. 6.

One record for individual print data is registered in the print data management table 400. Each record includes a field 402 in which a name of the print data is registered, a field 404 in which the user identification information is registered, and a field 406 in which the driver identification information is registered.

In a case shown in FIG. 6, for the record in the first row, “01” is registered as the name of the print data, and “01230001” and “PrinterDriver1” are registered as the user identification information and the driver identification information, respectively. This indicates that the print data with the print data name of “01” was crated by the user identified by the user identification information “01230001” using the printer driver “PrinterDriver1”. The name of the print data may be a job ID assigned to the print data, a file name of the print data, or an address of the print data on the storage device 63. When a general printer driver is used, or the printer driver is not used, the driver identification information is not necessarily registered.

The CPU 70 comprises a micro processing unit or the like, and runs a certain program stored in a specific region of the ROM 72, thereby performing print request acceptance processing, address information providing processing, and print data retrieval processing detailed, respectively, in the flowcharts of FIG. 7 through 9, in a time-divisional manner according to the program.

Firstly, the print request acceptance processing will be described in detail with reference to FIG. 7.

FIG. 7 is a flowchart detailing the print request acceptance processing.

The print request acceptance processing is processing to accept a print request from the host terminal 100, and when performed in the CPU 70, as is shown in FIG. 7, it first proceeds to Step S200.

In Step S200, whether a print request is received is judged. When it is judged that the print request is received (Yes), the flow proceeds to Step S202, and when it is judged otherwise (No), the flow is suspended in Step S200 until the print request is received.

In Step S202, the print data is received, and the flow then proceeds to Step S204 in which an acquisition request for the identification information is transmitted to the request-sender host terminal 100, after which the flow proceeds to Step S206.

In Step S206, whether the user identification information and the driver identification information are received is judged, and when it is judged that the user identification information and the driver identification information are received (Yes), the flow proceeds to Step S208, and when it is judged otherwise (No), the flow is suspended in Step S206 until the user identification information and the driver identification information are received.

In Step S208, the received print data is registered in the storage device 63, and the name of the print data, the user identification information, and the driver identification information thus received are registered in the print data management table 400 to have a correlation with one another, at which point a sequence of the processing is terminated and the original processing is resumed.

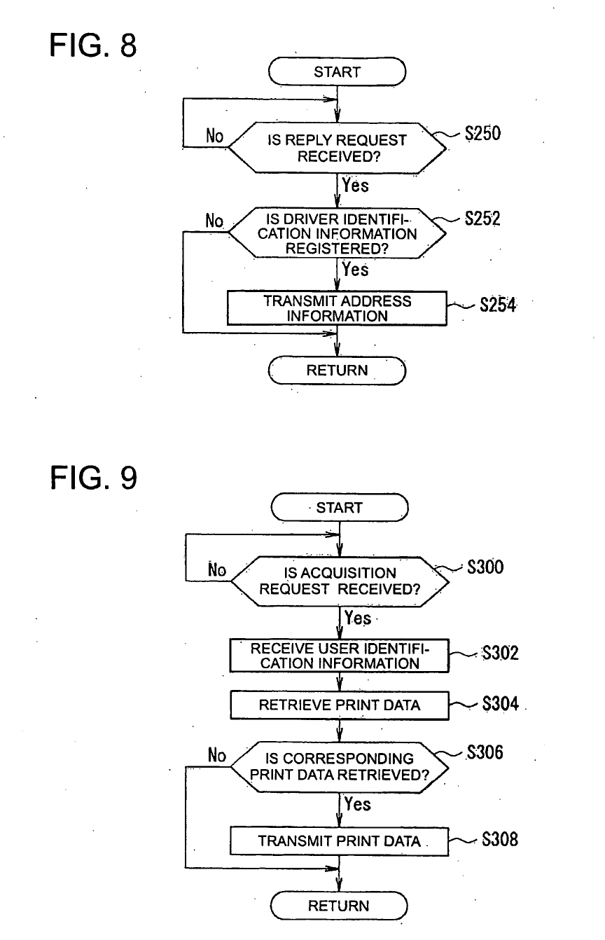

The address information providing processing will now be described in detail with reference to FIG. 8.

FIG. 8 shows a flowchart detailing the address information providing processing.

The address information providing processing is processing to provide the network printer 300 with the address information of the printer server 200 in response to a request from the network printer 300, and when performed in the CPU 70, as is shown in FIG. 8, it first proceeds to Step S250.

In Step S250, whether a reply request is received is judged. When it is judged that the reply request is received (Yes), the flow proceeds to Step S252, and when it is judged otherwise (No), the flow is suspended in Step S250 until the reply request is received.

In Step S252, whether the driver identification information corresponding to the request-sender network printer 300 is registered in the print data management table 400 is judged. When it is judged that the corresponding driver identification information is registered (Yes), the flow proceeds to Step S254 in which the address information indicating the own network address is transmitted to the request-sender network printer 300, at which point a sequence of the processing is terminated and the original processing is resumed.

Meanwhile, when it is judged in Step S252 that the driver identification information corresponding to the request-sender network printer 300 is not registered in the print data management table 400 (No), a sequence of the processing is terminated and the original processing is resumed.

The print data retrieval processing will now be described in detail with reference to FIG. 9.

FIG. 9 shows a flowchart detailing the print data retrieval processing.

The print data retrieval processing is processing to retrieve print data from the storage device 63, and when performed in the CPU 70, as is shown in FIG. 9, it first proceeds to Step S300.

In Step S300, whether an acquisition request for the print data is received is judged. When it is judged that the acquisition request for the print data is received (Yes), the flow proceeds to Step S302, and when it is judged otherwise (No), the flow is suspended in Step S300 until the acquisition request for print data is received.

In Step S302, the user identification information is received, and the flow then proceeds to Step S304 in which the print data corresponding to the user identification information identical with the received user identification information is retrieved from the storage device 63 with reference to the print data management table 400, after which the flow proceeds to Step S306.

In Step S306, whether the corresponding print data is retrieved is judged. When it is judged that the corresponding print data is retrieved (Yes), the flow proceeds to Step S308 in which the print data thus retrieved is transmitted to the request-sender network printer 300, at which point a sequence of the processing is terminated and the original processing is resumed.

Meanwhile, when it is judged in Step S306 that the corresponding print data cannot be retrieved (No), a sequence of the processing is terminated and the original processing is resumed.

The configuration of the network printer 300 will now be described.

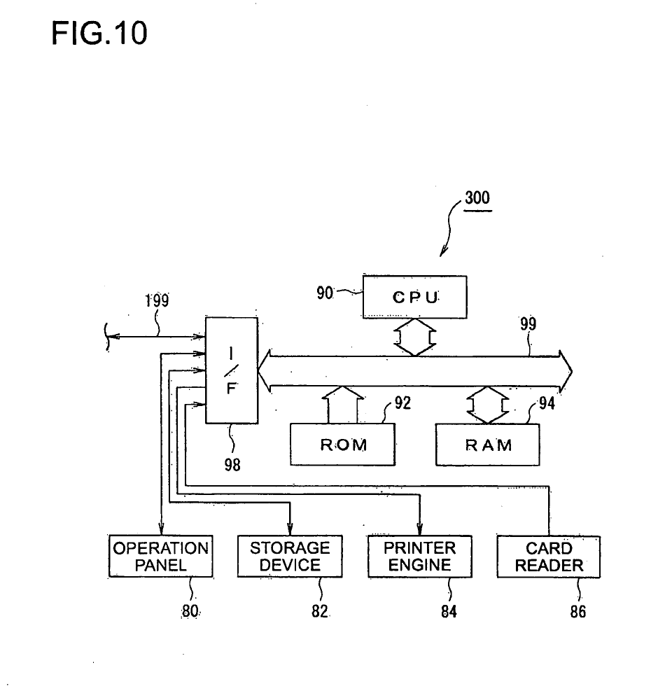

FIG. 10 is a block diagram showing the hardware configuration of the network printer 300.

As is shown in FIG. 10, the network printer 300 comprises a CPU 90 that performs a computation and controls the overall system according to a control program, a ROM 92 that pre-stores the control program of the CPU 90 or the like in a specific region, a RAM 94 that stores data read out from the ROM 92 or the like and a computation result needed for a computation process in the CPU 90, and an I/F 98 that transmits incoming/outgoing data from/to an external device. These components are interconnected via a bus 99 serving as a signal line for transferring data to enable mutual data reception and transmittance.

External devices are connected to the I/F 98, such as an operation panel 80 comprising a touch panel or the like serving as a human interface to enable data inputs and a display, a storage device 82 that stores data or a table in the form of files, a printer engine 84 comprising a print head, a head driving portion and other mechanisms need for printing, a card reader 86 that reads out user identification information from an inserted identification card, and a signal line for establishing a connection with the network 199.

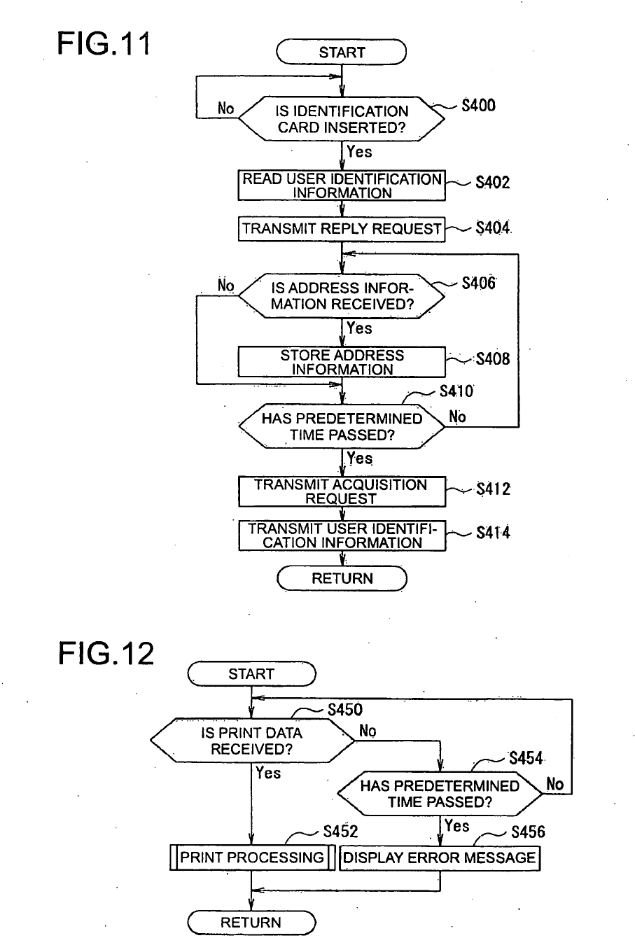

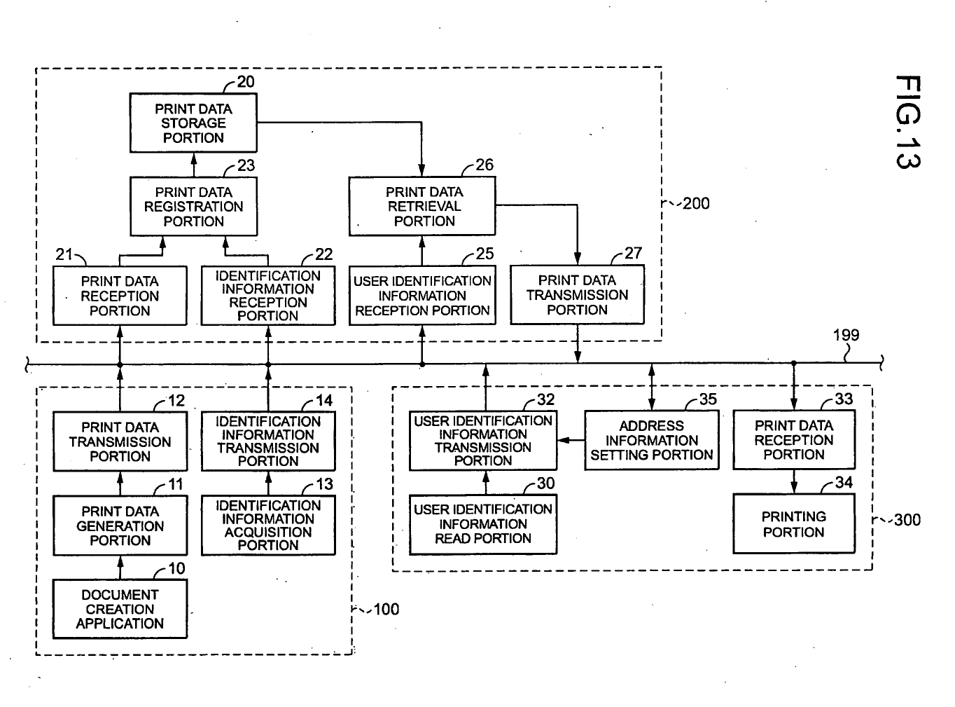

The CPU 90 comprises a micro processing unit or the like, and runs a certain program stored in a specific region of the ROM 92, thereby performing identification card read processing and print control processing detailed, respectively, in the flowcharts of FIG. 11 and FIG. 12, in a time-divisional manner according to the program.

Firstly, the identification card read processing will be described in detail with reference to FIG. 11.

FIG. 11 is a flowchart detailing the identification card read processing.

The identification card read processing is processing to read out the user identification information from an identification card by means of the card reader 86, and when performed in the CPU 90, as is shown in FIG. 11, it first proceeds to Step S400.

In Step S400, whether an identification card is inserted in the card reader 86 is judged. When it is judged that the identification card is inserted (Yes), the flow proceeds to Step S402, and when it is judged otherwise (No), the flow is suspended in Step S400 until the identification card is inserted.

In Step S402, the user identification information is read out from the identification card by means of the card reader 86, and the flow then proceeds to Step S404 in which a reply request is transmitted through broadcast communication, after which the flow proceeds to Step S406.

In Step S406, whether address information is received is judged, and when it is judged that the address information is received (Yes), the flow proceeds to Step S408 in which the received address information is stored in the storage device 82. The flow then proceeds to Step S410 in which whether a predetermined time (for example, 10 seconds) has passed since the reply request was transmitted is judged. When it is judged that the predetermined time has passed (Yes) the flow proceeds to Step S412.

In Step S412, an acquisition request for print data is transmitted to the printer server 200 according to the address information in the storage device 82, and the flow then proceeds to Step S414 in which the user identification information thus read is transmitted to the printer server 200 according to the address information in the storage device 82, at which point a sequence of the processing is terminated and the original processing is resumed.

Meanwhile, when it is judged in Step S410 that the predetermined time has not passed since the reply request was transmitted (No), the flow returns to Step S406.

Also, when it is judged in Step S406 that the address information is not received (No), the flow proceeds to Step S410.

The print control processing will now be described in detail with reference to FIG. 12,

FIG. 12 shows a flowchart detailing the print control processing.

The print control processing is processing to execute printing on the basis of the print data from the printer server 200, and when performed in the CPU 90, as is shown in FIG. 12, it first proceeds to Step S450.

In Step S450, whether print data is received is judged, and when it is judged that the print data is received (Yes), the flow proceeds to Step S452 in which printing is executed by means of the printer engine 84 on the basis of the received print data, at which point a sequence of the processing is terminated and the original processing is resumed.

Meanwhile, when it is judged in Step S450 that the print data is not received (No), the flow proceeds to Step S454 in which whether a predetermined time (for example, one minute) has passed since the acquisition request was transmitted in Step S412. When it is judged that the predetermined time has passed (Yes), the flow proceeds to Step S456 and an error message is displayed on the operation panel 80, at which point a sequence of the processing is terminated and the original processing is resumed.

Meanwhile, when it is judged in Step S454 that the predetermined time has not passed since the acquisition request was transmitted in Step S412 (No), the flow returns to Step S450.

Operations in this embodiment will now be described.

The user edits the document data using the document creation application 10 on the host terminal 100, and makes a request for printing.

When the printing is requested, the host terminal 100 follows Steps S102 through S106, thereby generating print data by means of the printer driver on the basis of the document data, and transmitting the generated print data to the printer server 200 together with the print request.

Upon receipt of the print request, the printer server 200 follows Steps S202 and S204, thereby receiving the print data and transmitting an acquisition request for identification information to the request-sender host terminal 100.

Upon receipt of the acquisition request for the identification information, the host terminal 100 follows Steps S152 through S156, thereby acquiring the user identification information of the user currently using the host terminal 100 and the driver identification information about the printer driver used when the print data is generated, and transmitting the user identification information and the driver identification information thus acquired to the printer server 200.

Upon receipt of the user identification information and the driver identification information, the printer server 200 follows Step S208, thereby registering the received print data in the storage device 63, so that the name of the print data, the user identification information, and the driver identification information thus received are registered in the print data management table 400 to have a correlation with one another.

The user then inserts the identification card into the card writer 66 of the host terminal 100, and writes his own user identification information into the card writer 66. Alternatively, the user identification information may have been written into the identification card previously.

The user then goes to the network printer 300, and inserts the identification card having recorded the user identification information into the card reader 86.

When the identification card is inserted into the card reader 86, the network printer 300 follows Step S402, thereby reading out the user identification information from the identification card by means of the card reader 86. It then follows Step S404, thereby transmitting a reply request through the broadcast communication.

Upon receipt of the reply request, the printer server 200 follows Step S252, thereby judging whether the driver identification information corresponding to the request-sender network printer 300 is registered in the print data management table 400. Because the corresponding driver identification information is registered unfailingly in either one of the printer servers 200, it is possible to judge the registration of the driver identification information in either one of the printer servers 200. When the registration of the driver identification information is judged, the printer server 200 follows Step S254, thereby transmitting the address information indicating its own network address to the request-sender network printer 300.

Upon receipt of the address information, the network printer 300 follows Step S408, thereby storing the received address information into the storage device 82. Then, the network printer 300 follows Steps S412 and S414, thereby transmitting the user identification information thus read to the printer server 200 together with an acquisition request for print data, according to the address information in the storage device 82.

Upon receipt of the acquisition request for print data, the printer server 200 follows Steps S302 and S304, thereby receiving the user identification information, and retrieving print data corresponding to the user identification information identical with the received user identification information from the storage device 63 by referring to the print data management table 400. Because the corresponding print data is registered unfailingly in either one of the printer servers 200, it is possible to retrieve the corresponding print data from either one of the printer servers 200. When the corresponding print data is retrieved, the printer server 200 follows Step S308, thereby transmitting the retrieved print data to the request-sender network printer 300.

Upon receipt of the print data, the network printer 300 follows Step S452, thereby executing printing on the basis of the received print data by means of the printer engine 84.

In a case where the corresponding driver identification information is not registered in the printer server 200, the printer server 200 will not transmit the address information even when it receives a reply request.

Also, in a case where an identification card having recorded user identification information other than the authorized user identification information is used, the printer data cannot be retrieved from any of the printer servers 200. The network printer 300 is therefore unable to receive the print data within the predetermined time. Hence, it follows Step S456, thereby displaying an error message on the operation panel 80.

As has been described, in this embodiment, the network printer 300 is configured to read out the user identification information from the identification card when the identification card is inserted, transmit the read user identification information to the printer server 200, and execute printing on the basis of the received print data upon receipt of the print data. Also, the printer server 200 is configured to retrieve, from the storage device 63, print data corresponding to the user identification information identical with the received user identification information upon receipt of the user identification information, and transmit the retrieved print data to the network printer 300.

When configured in this manner, printing is started when the user provides the identification card to the network printer 300. It is thus possible to reduce a risk that a third party will see the print contents, which can in turn enhance the security. In addition, because print data correlated with the user identification information is held in the printer server 200, there is no need for the network printer 300 to hold print data correlated with the user identification information. Hence, when a number of print requests are issued simultaneously or almost simultaneously, it is possible to reduce a possibility that printing is not executed in comparison with the related art. Further, even when a number of print requests are issued simultaneously or almost simultaneously, because print data is transmitted to the network printer 300 when printing is executed, it is possible to relieve traffic concentration in comparison with the related art. Moreover, because it is configured in such a manner that print data is acquired by transmitting the user identification information from the network printer 300, when more than one network printer 300 is present, printing can be executed on any of the network printers 300.

In addition, because print data is generated in the host terminal 100, a degree of freedom is large in generation of print data.

Further, in this embodiment, because the network printer 300 transmits a reply request through broadcast communication, and upon receipt of the address information, it transmits the user identification information read from the identification card to the printer server 200 according to the received address information. The printer server 200 therefore transmits its own address information to the request-sender network printer 300 upon receipt of a reply request.

This eliminates the need to pre-set the address information of the printer server 200 to the network printer 300, and the network printer 300 can be therefore readily installed. Further, because it is not necessary to set the address information of the printer server 200 in the network printer 300, even when the address information of the printer server 200 is changed, it is not necessary to correct the settings in the network printer 300.

Further, in this embodiment, the printer server 200 is configured not to transmit the address information to the request-sender network printer 300 when it judges that driver identification information corresponding to the request-sender network printer 300 is not registered in the print data management table 400.

This prevents transmission of the address information of the printer server 200 that is incompatible with the network printer 300, and therefore suppresses an increase of a traffic volume and processing load. In addition, because unnecessary address information is not received and transmitted over the network 199, a risk of leakage of address information can be reduced.

In the embodiment described above, the host terminal 100 corresponds to the device using apparatus in the mode 2 or 24. The print data generation portion 11 and Step S102 correspond to the output data generating means in the mode 2, and Step S102 corresponds to the output data generating step in the mode 24. Also, the print data transmission portion 12, the identification information transmission portion 14, and the I/F 58 as well as Steps S106 and S156 correspond to the second output data transmitting means in the mode 2. Steps S106 and S156 correspond to the second output data transmitting step in the mode 24, and the printer servers 200 correspond to the output data management apparatus in the mode 1, 2, 4, 7, 8, 10 through 13, 18, 20, 21, 23, 24, or 26.

Also, in the embodiment described above, the print data storage portion 20 and the storage device 63 correspond to the output data storage means in the mode 1, 2, 5, 7, 8, 11, 15, 16, 19, 23, 24, or 27. The print data reception portion 21, the identification information reception portion 22, and the I/F 78 as well as Steps 202 and 206 correspond to the second output data receiving means in the mode 2 or 6. Also, Steps S202 and S206 correspond to the second output data receiving step in the mode 16 or 24. The print data registration portion 23 and Step S208 correspond to the output data registration means in the mode 2 or 8, and Step S208 corresponds to the output data registering step in the mode 16 or 24.

Also, in the embodiment described above, the address information providing portion 24 and the I/F 78 as well as Steps S250 through S254 correspond to the reply request receiving means in the mode 4 or 10, or the position information transmitting means in the mode 4, 5, 10, or 11. Steps S250 through S254 correspond to the reply request receiving step in the mode 18 or 26, or the position information transmitting step in the mode 18, 19, 26, or 27. Also, the user identification information reception portion 25 and the I/F 78 as well as Step S302 correspond to the verification information receiving means in the mode 1 or 7. Step S302 corresponds to the verification information receiving step in the mode 15 or 23, and the print data retrieval portion 26 and Step S304 correspond to the output data retrieving means in the mode 1 or 7.

Also, in the embodiment described above, Step S304 corresponds to the output data retrieving step in the mode 15 or 23. The print data transmission portion 27 and the I/F 78 as well as Step S308 correspond to the output data transmitting means in the mode 1 or 7, and Step S308 corresponds to the output data transmitting step in the mode 15 or 23. Also, the network printer 300 corresponds to the network device in the mode 1, 2, 4, 5, 10 through 13, 18, 19, 23, 24, 26, or 27, and the user identification information read portion 30 and the card reader 86 as well as Step S402 correspond to the verification information acquisition means in the mode 1, 4, 12, or 13.

Also, in the embodiment described above, Step S402 corresponds to the verification information acquiring step in the mode 20, 21, 23, or 26. The address information acquisition portion 31 and the I/F 98 as well as Steps S404 and S406 correspond to the reply request transmitting means in the mode 4 or 13, or the position information receiving means in the mode 4 or 13. Also, Steps S404 and S406 correspond to the reply request transmitting step in the mode 21 or 26, or the position information receiving step in the mode 21 or 26. The user identification information transmission portion 32 and the I/F 98 as well as Step S414 correspond to the verification information transmitting means in the mode 1, 4, 12, or 13.

Also, in the embodiment described above, Step S414 corresponds to the verification information transmitting step in the mode 20, 21, 23, or 26. The print data reception portion 33 and the I/F 98 as well as Step S450 correspond to the output data receiving means in the mode 1 or 12, and Step S450 corresponds to the output data receiving step in the mode 20 or 23. Also, the printing portion 34 and the printer engine 84 as well as Step S452 correspond to the output means in the mode 1 or 12. Step S452 corresponds to the output step in the mode 20 or 23, and the user identification information corresponds to the verified information in the mode 1, 2, 5, 7, 8, 11, 15, 16, 19, 23, 24, or 27, or the verification information in the mode 1, 4, 7, 12, 13, 15, 20, 21, 23, or 26.

Also, in the embodiment described above, the address information corresponds to the position information in the mode 4, 5, 10, 11, 13, 18, 19, 21, 26, or 27, and the print data corresponds to the output data in the mode 1, 2, 5, 7, 8, 11, 12, 15, 16, 19, 20, 23, 24, or 27. The printer driver corresponds to the device driver in the mode 5, 11, 19, or 27.

In the embodiment above, the system is configured to include the printer servers 200. However, the invention is not limited to this configuration. The printer servers 200 may be omitted, and instead the function of the printer servers 20, may be provided to the host terminals 100. In this case, it is sufficient to provide the print data storage portion 20, the print data registration portion 23, the address information providing portion 24, the user identification information reception portion 25, the print data retrieval portion 26, and the print data transmission portion 27 to each host terminal 100.

When configured in this manner, because print data is generated in the host terminal 100, there is no need to newly provide the printer server 200. In addition, the security is high because print data is held in the user's own host terminal 100.

In this case, the host terminal 100 corresponds to the output data management apparatus in the mode 3, 9, or 25. The print data storage portion 20 corresponds to the output data storage means in the mode 3, 9, 17, or 25, and the print data generation portion 11 corresponds to the output data generating means in the mode 3 or 9. Also, the print data registration portion 23 corresponds to the output data registration means in the mode 3 or 9.

Also, in the embodiment described above, the network printer 300 is configured to acquire the address information from the printer server 200, and to access the printer server 200 according to the acquired address information. However, the invention is not limited to this configuration, and it may be configured in such a manner that the address information is set in the network printer 300, so that the network printer 300 is able to access the printer server 200 according to the address information set therein. Hereinafter, this configuration will be described concretely only the portions different from the embodiment above will be described; like portions are labeled with like reference numerals with respect to the embodiment above, and the descriptions of such portions are omitted herein.

FIG. 13 is a functional block diagram schematically showing a function of the network system.

Each printer server 200 includes a print data storage portion 20, a print data reception portion 21, an identification information reception portion 22, a print data registration portion 23, a user identification information reception portion 25, a print data retrieval portion 26, and a print data transmission portion 27.

A network printer 300 includes a user identification information read portion 30, a user identification information transmission portion 32, a print data reception portion 33, and a printing portion 34 as well as an address information setting portion 35 that sets address information of the printer server 200.

For example, address information is inputted from the operation panel 80, and the address information setting portion 35 sets the address information by storing the input address information into a storage device 82. In an other setting method, the address information setting portion 35 receives a file written with the address information, reads out the address information from the received file, and stores the read address information into the storage device 82.

The user identification information transmission portion 32 transmits the user identification information to the printer server 200 according to the address information set by the address information setting portion 35.

When configured in this manner, because the network printer 300 communicates with the designated printer server 200 alone, it is possible to prevent stealing or falsification of print data through impersonation.

In this case, the address information setting portion 35 corresponds to the position information setting means in the mode 6 or 14.

Also, in the embodiment described above, the network printer 300 is configured to read the user identification information from the identification card by means of the card reader 86. However, the invention is not limited to this configuration, and it may be configured in such a manner that the user identification information is inputted from the operation panel 80. Alternatively, it may be configured in such a manner that a fingerprint reader is provided to the network printer 300, so that fingerprint information is read by means of the fingerprint reader as the user identification information. Likewise, it may be configured in such a manner, that the fingerprint information is read by means of a Felica or a numerical pad as the user identification information. Further, not only the fingerprint authentication, but also palm authentication and eye retina authentication may be used.

Also, in the embodiment described above, the network printer 300 is configured to transmit a reply request through broadcast communication. However, the invention is not limited to this configuration, and it may be configured in such a manner that a reply request is transmitted through multicasting communication or any other simultaneous transmission system.

Also, in the embodiment described above, it is configured in such a manner that the print data storage portion 20 is provided to the printer server 200. However, the invention is not limited to this configuration, and it may be configured in such a manner that the print data storage portion 20 is provided to the host terminal 100 or terminals other than the network printer 300.

Also, the embodiment described above described cases where the control programs pre-stored in the ROMs 52, 72, and 92 are run to perform the processing detailed in the flowcharts of FIG. 3, FIG. 4, FIGS. 7 through 9, FIG. 11, and FIG. 12. However, the invention is not limited to these cases, and the a program written with the procedure may be readout from a recording medium having recorded the program, and written into the RAMs 54, 74, and 94 for the processing to be performed.

The recording medium referred to herein includes a semiconductor storage medium, such as a RAM and a ROM, a magnetic memory storage medium, such as an FD and an HD, an optical reading storage medium, such as a CD, a CDV, an LD, a DVD, a magnetic memory/optical reading storage medium, such as an MO, and includes all kinds of storage media as long as they are computer-readable storage media whether an electronic, magnetic, or optical reading method is adopted.

Also, the embodiment described above described the output system, the output data management apparatus, the network device, the output data management program, the output program, and the output method of the invention through a case where, as is shown in FIG. 1, printing is executed on the network printer 300 using the identification card. However, the invention is not limited to this case, and the invention is applicable to any other cases within the scope of the invention. The network printer 300 may be replaced by, for example, a projector, a home gate way, a personal computer, a PDA (Personal Digital Assistant), a network storage, audio equipment, a cellular phone, a PHS (Registered Trademark) (Personal Handyphone System), a watch-type PDA, an STB (Set Top Box), a POS (Point Of Sale) terminal, a facsimile machine, a telephone (including an IP phone or the like), and any other output apparatus. In short, the invention is applicable to any apparatus with an output capability.

For example, a case where the invention is applied to a projector is as follows. That is, when more than one user uses a single projector, only the data of the user who comes to the projector is displayed. This is effective in a case where it is preferable to conceal data from a third party until a presentation begins.

For example, a case where the invention is applied to a display is as follows. That is, secure data is displayed on the display only when the user of the data uses the display.

1. An output system in which a network device that performs an output on the basis of output data and an output data management apparatus that manages the output data are connected to enable communications for allowing the network device to perform the output, characterized in that:
the output data management apparatus includes output data storage means for storing the output data and verified information to have a correlation with each other, verification information receiving means for receiving verification information that is checked against the verified information, output data retrieving means for retrieving the output data from the output data storage means according to the verification information received at the verification information receiving means, and output data transmitting means for transmitting the output data retrieved by the output data retrieving means; and
the network device includes verification information acquisition means for acquiring the verification information, verification information transmitting means for transmitting the verification information acquired by the verification information acquisition means to the output data management apparatus, output data receiving means for receiving the output data, and output means for performing the output on the basis of the output data received at the output data receiving means.

2. The output system according to claim 1, further including:
a device using apparatus that uses the network device and is connected to the system to enable communications,
wherein the device using apparatus includes output data generating means for generating the output data, and second output data transmitting means for transmitting the output data generated in the output data generating means and the verified information to the output data management apparatus; and
the output data management apparatus further includes second output data receiving means for receiving the output data and the verified information, and output data registration means for registering the output data and the verified information received at the second output data receiving means in the output data storage means to have a correlation with each other.

3. The output system according to claim 1, wherein:
the output data management apparatus further includes output data generating means for generating the output data, and output data registration means for registering the output data generated in the output data generating means and the verified information in the output data storage means.

4. The output system according to any of claims 1 through 3, wherein:
the network device further includes reply request transmitting means for transmitting a reply request through a simultaneous transmission system, and position information receiving means for receiving position information of the output data management apparatus;
the verification information transmitting means transmits the verification information acquired by the verification information acquisition means to the output data management apparatus according to the position information received at the position information receiving means; and
the output data management apparatus further includes reply request receiving means for receiving the reply request, and position information transmitting means for transmitting the position information to the network device as a request sender in response to the reply request received at the reply request receiving means.

5. The output system according to claim 4, wherein:
the output data storage means stores the output data to have a correlation with driver identification information about a device driver of the network device and the verified information; and
the position information transmitting means does not transmit the position information to the network device as the request sender when judging that the driver identification information corresponding to the network device as the request sender is absent in the output data storage means.

6. The output system according to any of claims 1 through 3, wherein:
the network device further includes position information setting means for setting position information of the output data management apparatus; and
the verification information transmitting means transmits the verification information acquired by the verification information acquisition means to the output data management apparatus according to the position information set by the position information setting means.

7. An output data management apparatus that manages output data, characterized by including:
output data storage means for storing the output data and verified information to have a correlation with each other, verification information receiving means for receiving verification information that is checked against the verified information, output data retrieving means for retrieving the output data from the output data storage means according to the verification information received at the verification information receiving means, and output data transmitting means for transmitting the output data retrieved by the output data retrieving means.

8. A network device that performs an output on the basis of output data characterized by including:
verification information acquisition means for acquiring verification information, verification information transmitting means for transmitting the verification information acquired by the verification information acquisition means to an output data management apparatus, output data receiving means for receiving the output data, and output means for performing the output on the basis of the output data received at the output data receiving means.

9. An output data management program that manages output data, characterized by including a program causing a computer to perform processing including:
a verification information receiving step of receiving verification information that is checked against verified information, an output data retrieving step of retrieving the output data from output data storage means having stored the output data and the verified information to have a correlation with each other according to the verification information received in the verification information receiving step, and an output data transmitting step of transmitting the output data retrieved in the output data retrieving step.

10. An output control program that performs an output on the basis of output data, characterized by including a program causing a computer to perform processing including:
a verification information acquiring step of acquiring verification information, verification information transmitting step of transmitting the verification information acquired in the verification information acquiring step to an output data management apparatus, an output data receiving step of receiving the output data, and an output step of performing the output on the basis of the output data received in the output data receiving step.

11. An output method for performing an output by means of a network device by connecting the network device that performs an output on the basis of output data and an output data management apparatus that manages the output data to enable communications, characterized by including:
for the network device, a verification information acquiring step of acquiring verification information that is checked against verified information, and a verification information transmitting step of transmitting the verification information acquired in the verification information acquiring step to the output data management apparatus;
for the output data management apparatus, a verification information receiving step of receiving the verification information, an output data retrieving step of retrieving the output data from output data storage means having stored the output data and the verified information to have a correlation with each other according to the verification information received in the verification information receiving step and an output data transmitting step of transmitting the output data retrieved by the output data retrieving step; and
further, for the network device, an output data receiving step of receiving the output data, and an output step of performing the output on the basis of the output data received in the output data receiving step.
